(19) United States
(12) Patent Application Publication
(10) Pub. No.: US 2003/0167408 A1
(43) Pub. Date: Sep. 4, 2003

(54) Randomized bit dispersal of sensitive data sets

(76) Inventors: Gregory P. Fitzpatrick, Keller, TX (US); Jeffrey Heming, Southlake, TX (US)

Correspondence Address: IBM Corporation, Intellectual Property Law, Internal Zip 4042, 8051 Congress Avenue, Boca Raton, FL, 33487, US

(21) Appl. No.: 10/086,401

(22) Filed: Mar. 1, 2002

(51) Int. Cl. H04L 9/00

(52) U.S. Cl. 713/201

(57) ABSTRACT

Secure storage of sensitive data sets in virtually insecure storage facilities is accomplished presently by storing small granular portions of the data (e.g. bits or bytes) in a randomly dispersed manner. The data sets contain information which requires secure handling. However, the granular portions are sufficiently small to ensure that they do not per se reveal any sensitive information, and they are so dispersed in storage that the probability of unauthorized access to useful information in any data set is extremely small. As an example of sensitive data subject to handling as presently contemplated, consider information pertaining to credit card accounts including cardholder, names and addresses associated with account numbers and cardholder identifying information such as social security numbers, etc. The present selection and dispersal of granular portions of this data effectively co-mingles portions of different data sets in storage in a random manner. Thus it would be extremely difficult if not impossible for a party acquiring unauthorized access to blocks of storage containing such data portions to be able to extract any useful or sensitive information therefrom.

### BACKGROUND OF THE INVENTION

This invention relates to a system and method for storing small (granular) portions of sets of data in a manner minimizing possibility of unauthorized access to sensitive or useful information (e.g. names and social security or credit account numbers) contained in the data sets.

As presently contemplated, the store or stores in which this data is held needn't be secure; e.g. they may be used to store both presently dispersed data blocks and other data, and they may be accessible through data communication networks, such as the Internet, which needn't be secure.

It is believed that presently known systems which allow for distributed storage of data at a granular level—including, for example, contemporary RAID storage systems—do not disperse sensitive data in a sufficiently random manner to avoid potentially compromising security of such data.

### SUMMARY OF THE INVENTION

In accordance with this invention, granular portions of data containing sensitive information are dispersed in storage in an apparently random manner, and at a level of granularity, such that the likelihood of security of the important information being compromised is extremely small. Data containing sensitive information requiring such handling could be table containing credit account lists, wherein potentially important information associated with a single account—e.g. user name, address, account number, social security number, pin number, etc.—is contained in a row or column. Obviously, it is desirable to ensure that when such information is stored in media potentially subject to unauthorized access, the information per se is not discernible.

The present invention solves this problem by randomly dispersing granular portions of such data in storage, at a level of bit granularity effectively ensuring that security of important/sensitive information as stored is not potentially compromised. The granular portions of the data are inserted into randomly selected locations of queues, each queue serving to collect data from plural sources into a large block effectively consisting of disassociated and randomly dispersed granular elements of data collected from these sources. As the granular portions of data are dispersed in this manner, metadata—i.e. data containing information for locating individual granular portions—is retained, so as to permit retrieval and reassembly of the granular portions into the original data from which they were extracted.

As each block is filled it is sent to a remote storage system. In that system the blocks are randomly dispersed into plural stores that are either physically or virtually separate. Furthermore, in the remote system, each block is redundantly stored in more than one store so as to increase the possibility of recovery from failure of any single store. The remote system provides the system from which each block is received with additional metadata for locating and retrieving the respective block. Thus, to reassemble data for processing, the present system uses metadata to retrieve blocks from the remote system into which the data has been dispersed, and additional metadata to locate and reassemble granular portions into their original relational form. If a block retrieval operation is unsuccessful, the present system uses other location metadata to retrieve the respective block from an alternate store unit in the remote system.

In addition to the foregoing, to further enhance security, the present system may encrypt each (disassociated and dispersed) block prior to sending it to the remote system. This however, adds the additional step of decrypting the respective block upon its retrieval.

Thus, in the event of unauthorized access to data stored in the remote system, it is ensured presently that sensitive portions of the data are not viewable without the retained metadata; and, if applicable, without the key to decryption. Summarizing the foregoing, features of this invention include:

1. Storage of granular components of sensitive data sets in randomly selected locations of potentially insecure storage facilities; e.g. facilities connected to networks used both by processing systems permitted to have access to respective data sets and processing systems not entitled to such access.

2. Storage of aforementioned granular components in storage facilities connected to public data communication networks such as the Internet.

3. Storage and tracking of meta-representations useful for locating and retrieving stored granular portions incidental to retrieval of respective data sets.

4. Collection of aforementioned granular components in randomly selected locations within block queues from which data is dispatched to storage; the content of each queue thereby consisting of randomly placed granular components of the data which as collected are disassociated; i.e. have no useful relationship for revealing sensitive information in the original data.

5. Redundant storage in separate stores of each block dispatched from a block queue to storage, so as to allow for fault tolerant retrieval of respective blocks and thereby ensure fault tolerant reconstruction of the original data.

These and other features, benefits, advantages, and uses of this invention will be more fully understood from the following description.

### BRIEF DESCRIPTION OF DRAWINGS

FIG. 1 is a schematic block diagram suggesting general aspects of a data storage system conforming to the present invention.

FIG. 2A is a schematic of an exemplary data set subject to handling in accordance with this invention.

FIG. 2B is a schematic of an exemplary set of information—hereafter termed “meta-representations”—needed for locating granular portions of the data set of FIG. 2A when respective granular portions are stored in accordance with this invention.

FIG. 3 is a schematic block diagram showing how the system of FIG. 1 may be connected to networks, including public networks like the Internet, which can not per se protect against unauthorized access to information stored therein.

FIG. 4 is a flowchart for explaining, on a broad level, operations performed in the system of either FIG. 1 or FIG. 3 to randomly disperse granular data elements and blocks of disassociated elements of multiple data sets in accordance with this invention.

FIG. 5 is a flowchart for explaining, on a broad level, operations performed in presently contemplated systems for retrieving and reconstructing data having granular data elements randomly dispersed and stored in accordance with this invention.

FIG. 6 is a schematic block diagram showing details of logical organization of a presently contemplated system for random dispersal of granular components of sensitive data.

FIG. 7 is a block diagram, for explaining how queued blocks of data are transferred between the system of FIG. 6 and an external storage system suggested in that figure, and how such transferred blocks may be redundantly stored in the external system so as to facilitate recovery of blocks in the event of failure in the external system.

### DETAILED DESCRIPTION

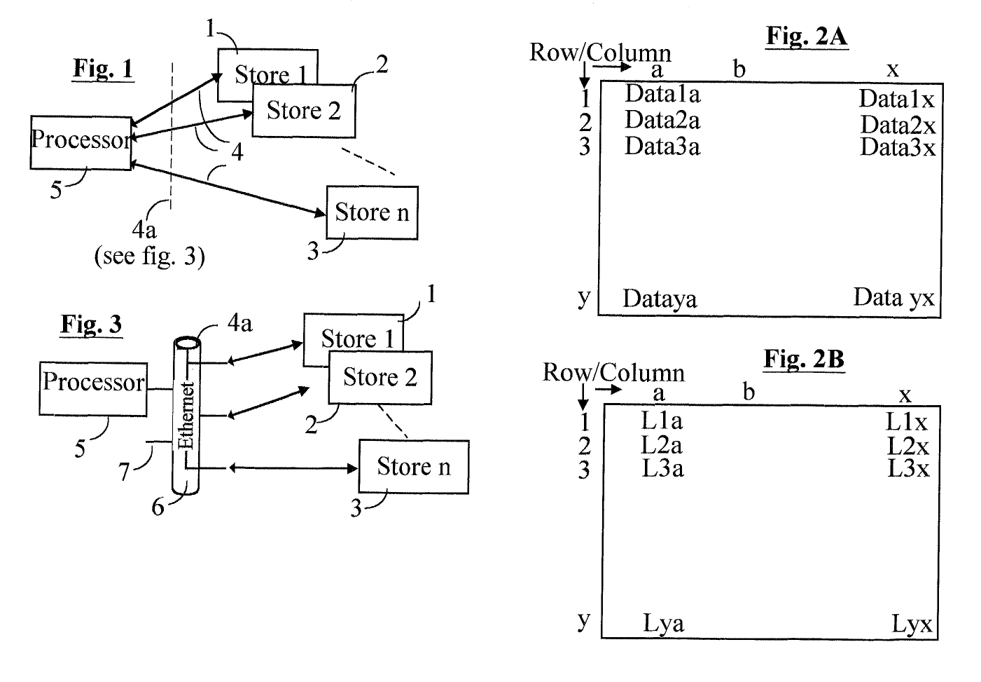

Referring to FIG. 1, storage facilities 1-3, having connections 4 to processing subsystem 5, are used to securely store sensitive data; for example tables or lists of credit account information containing names of credit card holders, respective account numbers, respective addresses and respective identifying indicia such as social security numbers. In accordance with this invention, granular portions of data sets (e.g. bit or byte portions of words or multiple words) are dispersed in storage so as to minimize likelihood of unauthorized access to the data sets.

As explained more fully below, the dotted line at 4a is intended to indicate that connections 4 may extend through communication networks, including public networks like the Internet.

Stores 1-3, which are intended to be useful to store both sensitive data requiring access security restrictions and other data, are viewed as virtually insecure since other data they may hold may not require access security restrictions.

An example of possibly sensitive data is suggested in FIG. 2A, and the present method employed to securely store such data is described with reference to FIGS. 2B, 4, 6 and 7. In FIG. 2A, data containing information to be protected is organized in the form of a rectangular table having rows “1, 2, . . . , y”, and columns “a, b, . . . ,x”. However, it will soon be understood that the invention is applicable to data ordered in forms other than tables; e.g. data having a predefined linear order. In this example, granular portions of the data in each row data set are designated in accordance with their row and column coordinates as “data ij” (i=1, 2, . . . , y; and j=a, b, . . . , x).

As suggested earlier, a data set occupying one or more rows could consist of the name of a credit account holder, a respective credit account number assigned to that individual, the holder's address, and information identifying the owner and the account, such as social security and pin numbers. Thus, information in such a data set, when viewed as a whole, is apparently sensitive and should not be subject to unauthorized access, although individual granular portions (e.g. part of a social security number or pin number without a name or address, part of a name without related information, part of an address, etc.) may not be meaningful or sensitive.

As suggested in FIG. 3, connections 4a between stores 1-3 and processor 5 can be formed through a data communication network 6—shown in this example as an Ethernet LAN (Local Area Network) type of facility, but understood to include other networks such as the Internet—having nodes of connection 7 to processing entities other than the processing system 5 which serves to disperse data in accordance with this invention. Thus, stores 1-3 may be considered insecure considering their possible connections 7 to other processors and their possible use to store data that is not handled in accordance with this invention.

Transfer of Data to and Retrieval of Data from Stores 1-n

A. Writing Data Sets to Distributed Stores

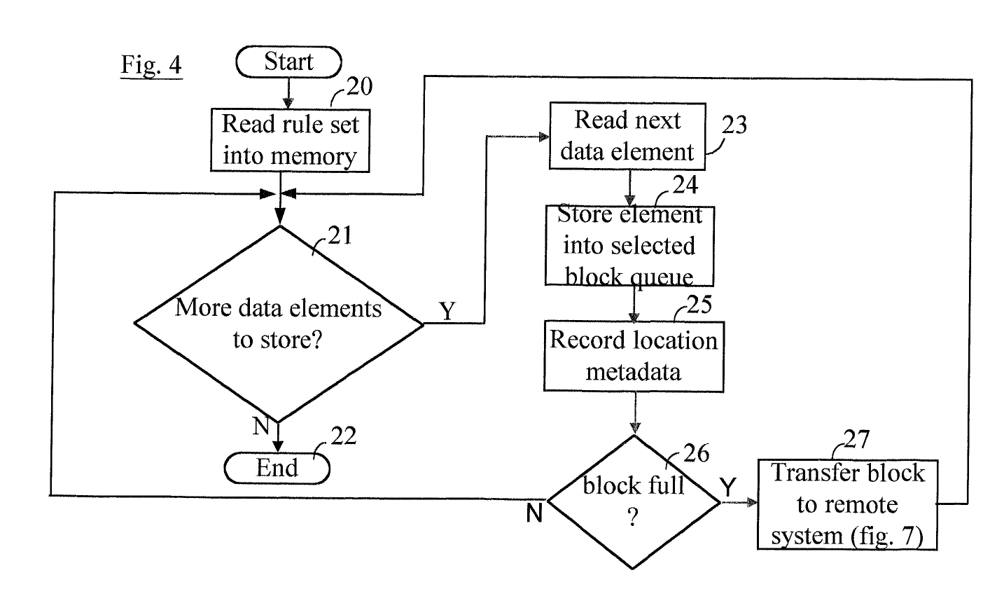

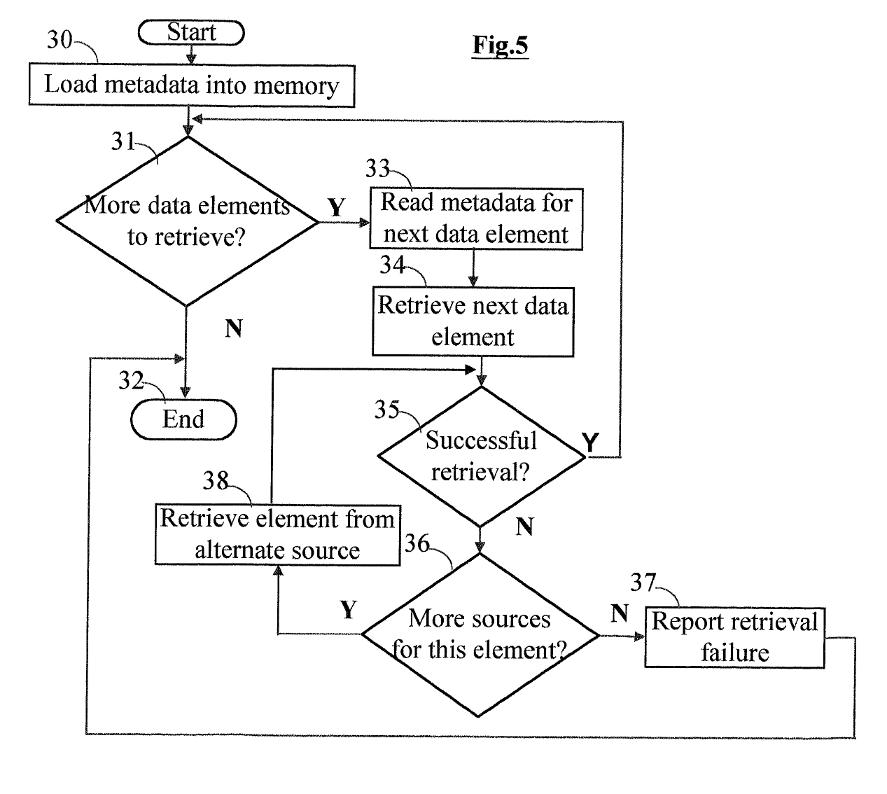

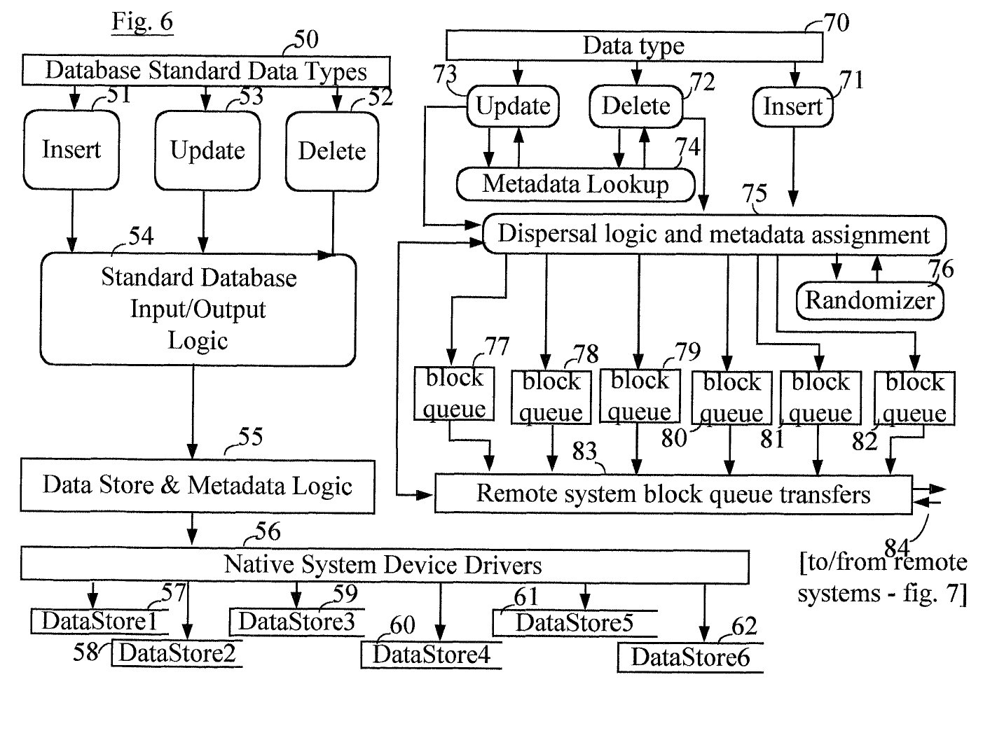

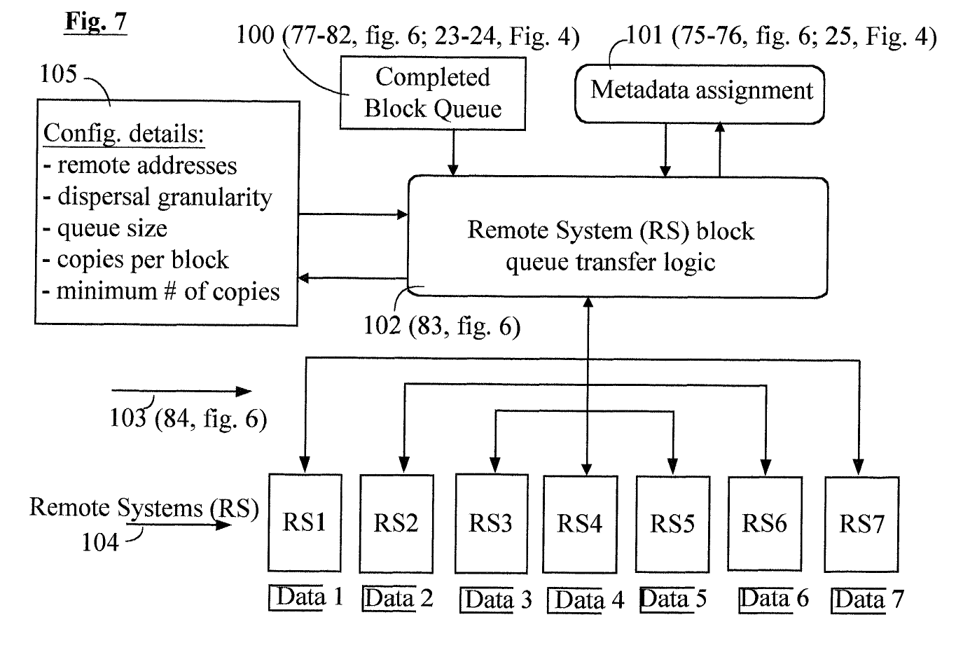

Random dispersal of (non-sensitive) granular portions of sensitive data, in accordance with this invention, is explained generally with reference to FIGS. 2A, 2B, and 4. Retrieval and reassembly of such granular portions into the sensitive data from which they originated is explained later with reference to FIG. 5. Details of associated logic and logical processes and features of present granular dispersal and retrieval are explained later with reference to FIGS. 6 and 7.

In the following discussions, FIG. 4 shows the presently contemplated process of granular dispersal, FIG. 2A suggests relationships between sensitive data sets and respective granular portions thereof, FIG. 2B shows the form in which metadata (information for locating and retrieving data sets stored in accordance with this invention) is retained in association with respective dispersed granular portions of respective data sets, FIG. 6 shows details of logical organization of a preferred system in accordance with the invention, and FIG. 7 shows additional details of that system.

As indicated earlier, each row in FIG. 2A may comprise a data set containing sensitive information, and granular portions of data at row and column intersects in that figure represent granular portions or elements of the set which individually do not contain sensitive information due to their small (bit) sizes. In accordance with this invention, these granular elements are randomly dispersed as described below.

The elements are dispersed first into randomly chosen locations within queued blocks—which may receive data from more than one source data set—and the blocks, when full, are transferred as storage files to stores which are either physically or virtually separate from each other. The filled blocks can be stored in a single store, if redundant storage of individual blocks (as discussed later) is not required and if the level of granularity and method of transfer are sufficiently random in time so as not to potentially compromise security of the original data.

As elements are dispersed to blocks, metadata information is retained for indicating locations of respective elements in specific blocks. As blocks are transferred to storage, additional metadata information is retained for locating respective blocks for retrieval. The form of retention of the metadata, which may be enciphered to further enhance security, is suggested in FIG. 2B, wherein row and column intersections correspond to like numbered intersections in FIG. 2A. Each intersection in FIG. 2B contains sufficient metadata information for locating and retrieving both a remotely stored block of (non-sensitive) data, containing a dispersed granular element of data originally located at the corresponding intersection in FIG. 2A, and for determining the position of the respective granular element within that block. This metadata also may be dispersed in discretely separate storage media provided that other information is retained for retrieving it.

Referring to FIG. 4, at the beginning of the granular dispersal process, rules defining the process are read into memory (step 20, FIG. 4), and granular elements of data are processed for dispersal in sequence, until there are no more elements to process (decision 21, FIG. 4). When there are no more elements to process, the dispersal process ends (step 22, FIG. 4). If more elements are available to disperse, the system executes processes indicated at 23-27.

As each element to be dispersed is read by the system (step 23, FIG. 4) it is transferred into a randomly selected block queue (step 24, FIG. 4). Each block queue collects elements until it is full, whereupon the respective block is transferred to external storage (refer to discussions below of FIGS. 6 and 7). Since successive elements of a data set are transferred into randomly selected block queues at different times, between which elements of other sets may be inserted into the queues, positions of successive elements of a set in the block queues are also effectively randomized. The form and content of the block queues will be understood from later discussions of FIGS. 6 and 7. As each element is transferred to a block queue, metadata—data identifying the selected block queue and location therein of the respective element—is recorded by the processing system (step 25, FIG. 4).

At successful completion of operations 24 and 25, the system determines if the just-selected block queue is full (decision 26, FIG. 4). If it is full, the (now randomly dispersed) data block content of that queue is transferred to remote storage (operation 27), and the processing system returns to decision point 21 to continue filling the block queues with more data elements while such are available. If the selected queue is not full, the system returns to decision point 21 without further action relative to the respective queue. Transfer of block queues to remote storage are further explained below in discussions of FIGS. 6 and 7.

Although not explicitly shown in FIG. 4, it will be understood (from later discussions of FIGS. 6 and 7) that in conjunction with each transfer of a filled block to remote storage, additional metadata is recorded for use in locating and retrieving the respective block. Also, although not explicitly indicated in FIG. 4, it will be understood from discussion of FIG. 7 below that in the remote system a transferred block may be redundantly stored in two or more discrete stores, and in such instances metadata recorded in the remote system will contain information for locating alternative copies of a transferred block. Thus, with the last-mentioned feature, metadata recorded by the dispersing system and the remote storage system would be sufficient to allow for recovery of a stored block in the event of a retrieval failure.

B. Retrieving and Reassembling Sensitive Data

Retrieval of granular portions of data sets, dispersed into blocks and stored as described above, and reassembly of retrieved portions into respective original sets, is described next with reference to FIGS. 5, 2A and 2B. Details of logic associated with these processes are described later with reference to FIG. 6.

To start retrieval of a particular data set, metadata for locating the dispersed granules of that set and the stored blocks containing those granules is loaded into the system memory (step 30, FIG. 5). Next, the system determines if all relevant data elements (i.e. granules) have been retrieved (decision 31, FIG. 5). When all relevant data elements have been retrieved the process ends as shown at 32; but if more data elements are to be retrieved, the system branches to perform operations 33-38 (some conditionally).

In operation 33 metadata is read for locating the next relevant data element. Then in operation 34, that metadata is used to locate and retrieve the stored block containing that element and to extract that element from that block (see also descriptions of FIGS. 6-7 below).

Decision 35 tests the successfulness of operations 34. If those operations are successful (yes result at decision 35)—i.e. if the next relevant data element has been successfully retrieved—the process returns to decision 34 to process additional data elements of the respective data set, if there are such. If operations 34 are unsuccessful (e.g. due to failure to retrieve the appropriate block from remote storage or failure to find the relevant data element at its appropriate location in that block), the system acts at decision 36 to determine if alternate sources of the relevant block are available in remote storage. In general, each data block described above will be redundantly stored in at least two stores so as to increase the likelihood of recovery of data in the event of storage failure.

If an alternate source is available, operations 38 are performed to retrieve the block from that source. Such operations may include reading and use of alternate metadata associated with the alternate source, if the function of locating the alternate source is not automatically performed in the remote storage system (see descriptions of FIGS. 6-7 below). The system then tests the success of these alternate retrieval functions via decisions 35 and 36.

If retrieval is still unsuccessful, and no other source is available for the element currently being processed, failure of retrieval is recorded at operation 37 and the retrieval process terminates.

C. Details of Logical Implementation

Details of logic associated with storage and retrieval processes described above are explained with reference to FIGS. 6 and 7.

FIG. 6 shows logic associated with conventional handling of non-sensitive data and handling of sensitive data in accordance with our invention. Blocks 50-62, on the left side of this figure, are used exclusively for conventional handling of non-sensitive data, and blocks 70-84, on the right side of the figure are used for presently contemplated granular dispersal and retrieval handling of sensitive data in accordance with our invention. Data flows on both sides of this figure are mostly bidirectional.

Non-sensitive data blocks, received originally at 50 from not-shown systems external to the illustrated system, are written to data stores 57-62, without granular dispersal, by actions described below. Data so stored is read/retrieved from the stores by other actions described below. Connections for transferring data through blocks 50-56 to stores 57-62, are bidirectional, so as to accommodate both writing of data to the stores and reading of data from the stores. In writing operations, data blocks received at 50 receive conventional insertion, deletion, and update handling, under control of functional blocks shown at 51, 52 and 53, respectively, and pass without granular dispersal—via conventional database logic 54-56—to stores 57-62. Data blocks held in stores 57-62 are retrieved through actions of blocks 54-56, and either returned to systems or subsystems external to the illustrated system via block 50 or modified (at 51, 52, or 53) and returned to the stores.

Above-mentioned insertion, deletion and update handling refers to well known processes associated with database applications. In insertion and deletion handling, data is respectively inserted into and removed from a portion of a data block. In update handling an entire block or several portions thereof are modified by insertion and/or removal of data.

Addresses at which non-sensitive data blocks are written to storage are determined by operations of (Input/Output) logic 54 and (Store and Metadata) logic 55. These addresses are passed to (Native) Device Drivers 56 controlling writing and reading block transfers. In writing transfers, logic 54-55 cooperates with drivers 56 to store block locating information (metadata) associated with addresses at which respective blocks are written. In reading transfers, logic 54-55 operates drivers 56 first to retrieve block metadata information and thereafter to retrieve data blocks from locations defined by or associated with the metadata information. Retrieved data blocks are transferred to buffers 50 from which respective data may be transferred to not-shown systems or subsystems external to the illustrated system.

Sensitive data sets, received originally at 70, are granularly dispersed into queued blocks which when full are written to external stores not shown in FIG. 6 but viewed in FIG. 7. Transfers into the queued blocks and transfers of queued blocks to external stores are randomized so as to ensure that granular elements of data, as stored, do not convey or imply sensitive information. When access to a sensitive data set is required, stored blocks containing granularly dispersed elements of the set are retrieved from the external stores. Respective dispersed elements are extracted from these blocks and re-assembled into the associated data set.. Connections on this side of FIG. 6 are also mostly bidirectional so as to accommodate transfers of data to and from the external stores.

In transfers to the external stores, data—received at 70 or retrieved from the external stores—receives insertion, deletion, and update handling in respective blocks 71-73, undergoes randomized bit dispersal by actions of logic 74-76, and passes to randomly selected ones of block queues 77-82. Each block queue is used to collect bits or other granular portions of dispersed data, and when the queue is full the respective block is written to a randomly selected one of multiple external stores. It is understood that each block so written consists of disassociated granular data; that is, granular elements of data randomly placed into the block in such fashion that there is very little possibility of adjacent elements having informational associations inter se.

As the block queues, are filled their contents are transferred to the not-shown external stores via connections shown at 84. These not-shown stores and their usage are shown in FIG. 7 and described below in reference to that figure.

In retrieval and reassembly processes, queued data blocks are retrieved and buffered in individual ones of block queues 77-82 by operations of logic 83. Each block so buffered is processed to extract one or more dispersed granular elements belonging to a specific original data set. Granular elements so extracted are re-assembled into original sensitive data set formats by operations of logic 74-76, undergoes insertion, deletion and update handling by actions of logic 71-73, and buffered in block 70; either for return to systems or subsystems external to the illustrated system or for further granular dispersal to blocks written to external stores via connections 84.

Granular dispersal processes for writing data granules to block queues and filled blocks to external stores are those described above for FIG. 4. Granular retrieval processes, performed in reverse relative to the external stores and the block queues, are those described above in reference to FIG. 5.

In dispersal writing, granular elements of a sensitive data set received at 70 are transferred into block queues 77-82, by operations of logic 74-76. Logic 74-76 selects queues to receive such elements on a randomized basis, and stores metadata—indicating respective queues and granular locations therein—for use in subsequent reassembly of retrieved portions into their original locations in respective data sets. In each block queue, successive spaces are filled when that queue is selected to receive granular elements.

Random selection of the block queues effectively ensures that within any queue originally adjacent granular elements of a data set will be separated from each other by arbitrary numbers of other granular elements taken from the same and other data sets. The size of the elements in bits (i.e. the level of granularity) should be sufficiently small to ensure that elements in a queue or any portion thereof do not have any sensitive or useful informational context.

When a block queue becomes full, its contents (consisting of randomly interspersed granular portions of one or more data sets) are transferred to a not-shown storage system external to the illustrated system (refer to description of FIG. 7 below), by actions of logic 83 relative to external connections 84. Logic 83 directs storage of associated metadata information, and tracks locations of that information, so as to allow for return of retrieved blocks to queues from which they were transferred and extraction of granular data elements into associated positions in respective (sensitive) data sets.

For retrieval of sensitive data from the external storage systems, blocks containing granular elements of a data set are read from the external systems to queues 77-82, by operations of logic 83, and respective granular elements of the set are extracted from the blocks, and assembled into their original formation in the data set, under the direction of logic 74-76. Extracted portions may be transferred to buffers 70 and modified in transit by insertion, deletion, and/or update functions selectively executed by actions of logic 71-73. The data set at 70 is then either passed to an external system requesting that set, or returned to external storage via the granular dispersal processes described earlier.

D. Configuration and Usage of External Stores

FIG. 7 corresponds in part to the right side of FIG. 6, but shows details of the external block storage systems, and details of block handling relative to those systems, that are not explicitly shown in FIG. 6. Where numbered items in FIG. 7 have corresponding parts in FIGS. 4 and 6, the corresponding part numbers are indicated in parentheses in FIG. 7. Thus, handling of completed block queues shown at 100 in FIG. 7 is seen to correspond to the block queues shown at 77-82 in FIG. 6, and logical functions 23-24 as seen in FIG. 4. Likewise, metadata assignment shown at 101 in FIG. 7 is understood to correspond to blocks 75-76 in FIG. 6 and logic functions 23-24 in FIG. 4. Likewise, block queue transfer logic at 102 is understood to correspond to block 83 in FIG. 6, and remote system connections indicated by arrow 103 are understood to correspond to connections 84 in FIG. 6.

Remote systems (RS1-RS7) indicated by arrow 104, and configuration details, shown at 105, do not have explicit counterparts in any other figure. Remote systems at 104 are the stores to which block queues are transferred and from which they are retrieved. As seen in configuration details at 105, in addition to details of dispersal granularity and queue size, the present system retains details pertaining to remote system addresses (block metadata), and the actual and minimum number of copies of each block in the remote systems.

In general, in respect to storage of block copies, it is preferred (as a feature of the present invention) that each block sent to a remote store have at least one actual copy sent to another (physically separate) remote store; so that in the event of failure of retrieval due to remote system error, the respective block is retrievable via the alternate location(s) of its copy (copies). Although it is generally known to allow for fault recovery by redundantly storing information, to do so in respect to the present dispersed data is considered to be a novel application of that technique.

E. Ancillary Considerations

Functions described above can be realized in hardware, software and combinations thereof. Software associated with such functions can be embodied in computer system programs. Such software can be stored in a variety of storage media, and applied to a respective computer system either directly from such media or through other means; such other means including data communication networks. For present purposes, all means for applying such software to systems performing the functions of this invention are considered “computer-readable media”. Software, in the presently intended context, comprises expressions—in any language, code or other form of notation—of instructions useful to cause systems in which they are installed to perform specific functions including the functions described above.

Another consideration presently is that security of sensitive data sets stored in accordance with our invention may be enhanced by storing data blocks containing dispersed granular components of such sets in an encrypted form, making it additionally difficult to extract useful information via unauthorized access to such blocks. Additionally, metadata useful to locate such data blocks in storage also may be stored in an encrypted form to assure their security. Encryption, in the presently intended context, involves transforming elements of data by various reversible rules or algorithms, including known hashing algorithms.

As noted earlier, redundant storage could be used to further enhance security of stored data in terms of the ability to retrieve such data when access to a particular store is blocked (e.g. due to failure of the store per se or of its connections to present retrieval logic. In such known methods for realizing fault tolerance, data blocks are stored redundantly in discrete stores, and access to such stores is arranged so that blocks are retrievable even when access to individual stores is blocked by a system fault. Thus, it is contemplated that individual blocks of data, formed in accordance with this invention (i.e. blocks containing disassociated granular components of sensitive data), could each be stored redundantly in plural separate stores, and that paths of connections to such stores also could be configured redundantly, so that a copy of each stored block is retrievable even if a store containing one copy becomes inoperative or otherwise inaccessible. Although use of redundancy to ensure fault tolerance is well known, it is believed that application of principles of such to the present storage of queued blocks, each containing randomly dispersed granular components of sensitive data, represents a new use of such known techniques.

Accordingly, we claim the following:

1. A system for distributed storage and reconstruction of a data set containing sensitive information, said system comprising:
an array of multiple stores; and
logic for randomly dispersing successive granular portions of data in said set into said stores, each said granular portion containing only information of a non-sensitive nature; whereby extraction of sensitive information in said data set from unauthorized access to data contained in said stores is extremely unlikely to occur.

2. A system in accordance with claim 1 wherein said logic for randomly dispersing comprises:
logic to transfer successive said granular portions into randomly selected block queues in an array of multiple block queues; each block queue holding multiple granular portions;
logic to detect when any of said block queues becomes filled; contents of each said filled block queue having only non-sensitive information; and
logic responsive to detection that a said block queue has become filled to transfer contents of the respective filled block queue to a randomly selected one of said stores in said array of stores.

3. A system in accordance with claim 1 wherein said processing subsystem is connected to said storage subsystem through a data communication network.

4. A system in accordance with claim 3 wherein said network comprises a local area network (LAN).

5. A system in accordance with claim 3 wherein said network extends through the Internet.

6. A system in accordance with claim 2 comprising:
logic for retaining metadata indicating locations of said granular portions of said data set within said array of stores; and
logic for using said retained metadata to retrieve said randomly dispersed granular portions from said stores and to reassemble the retrieved portions into their original positional relations in said data set.

7. A system in accordance with claim 6 wherein said retained metadata is enciphered and said logic for using said metadata to retrieve said granular portions includes logic for deciphering said retained metadata.

8. A system in accordance with claim 6 wherein said metadata contains representations of storage file names assigned to blocks of data in said stores containing randomly dispersed portions of said data set, and information indicating locations within said blocks of specific portions of said data set.

9. A system in accordance with claim 6 wherein said data set is in the form of a table having rows and columns, said dispersed portions are located originally at intersections of said rows and columns, and said retained metadata includes information for repositioning retrieved granular portions of said data set into specific row and column intersects of said table at which said portions were originally located prior to their dispersal into said stores.

10. A system in accordance with claim 6 wherein said retained metadata includes information defining storage locations of associated stored data blocks and of locations within each block of randomly dispersed granular elements of sensitive data contained in the respective block; and wherein said metadata is stored in an encrypted form.

11. A system in accordance with claim 2 wherein said logic is embodied in software for executing respective logical functions.

12. A system in accordance with claim 6 wherein each said filled block is stored in plural selected ones of said stores in said array of stores; whereby failure of any one of said plural stores would not prevent retrieval of the respective filled block.

13. A method for storing and reconstructing a set of data containing sensitive information, in a manner such that unauthorized access to the data as stored would not reveal any of said sensitive information, said method comprising:
transferring successive granular components of said set into randomly selected block queues in an array of multiple block queues; each said component being void of said sensitive information; each said block queue having capacity to store multiple said components;
monitoring said block queues to detect when they are full;
transferring content of each said full block queue to a randomly selected store in an array of multiple stores;
retaining metadata defining locations of said blocks of data in said stores and locations of individual said granular components within each said block; and
reassembling said data set by using said retained metadata to: (a) retrieve blocks of data containing all of the randomly dispersed granular components of said data set; (b) extract all of said randomly dispersed granular components of said data set from said retrieved data blocks; and (c) rearrange the extracted components into their original format within said data set.

14. The method of claim 13 wherein transferral of said full block queues to said stores is performed through a data communication network.

15. The method of claim 14 wherein said network includes a local area network.

16. The method of claim 14 wherein said network extends through the Internet.

17. The method of claim 13 wherein said retained metadata is ordered in correspondence to positions of said granular components within said data set as originally constituted.

18. The method of claim 17 wherein said retained metadata is enciphered and requires deciphering to be useful for locating said granular components.

19. The method of claim 17 wherein said data and said metadata are organized in tables having corresponding rows and columns.

20. The method of claim 13 wherein said transfers of said granular components to said block queues and transfers of said full block queues to said stores are performed by software.

21. The method of claim 13 wherein content of each said full block queue is stored redundantly in plural said stores, so that failure of access to any one of said stores would not prevent retrieval of the respective block queue contents contained in the respective store, and therefore would not prevent reassembly of said data set.

22. For a data handling and storage system, in which granular portions of data sets containing sensitive information are randomly dispersed in stores subject to orderly retrieval and reconstruction of respective sets, software installable in said system via computer-readable media, said software comprising:
elements for controlling functions requisite to said random dispersal of said granular portions; and
elements for controlling functions requisite to said orderly retrieval of said granular portions and reconstruction of said data sets.
